(19) United States
(12) Patent Application Publication
(10) Pub. No.: US 2023/0358582 A1
(43) Pub. Date: Nov. 9, 2023

(54) FLOWMETER AND METHOD

(71) Applicant: Spraying Systems Co., Wheaton, IL (US)

(72) Inventor: Peter Bramsen, Wheaton, IL (US)

(21) Appl. No.: 17/736,170

(22) Filed: May 4, 2022

(51) Int. Cl. G01F 1/60; G01F 17/00; G01K 13/02

(52) U.S. Cl. CPC G01F 1/60; G01F 17/00; G01K 13/026

(57) ABSTRACT

A flowmeter and method for measuring flow includes a container having a sidewall with an open end for collecting material in a cavity. A capacitive electrode is associated with the cavity and connected to a controller, which includes a power source that operates the capacitive electrode and a processing unit configured for receiving and processing signals from the capacitive electrode. The processor is programmed and configured to process the signals to determine a volume of material present in the collection cavity and a rate of change of the volume of material present in the collection cavity.

### BACKGROUND

Many commercial applications utilize spray nozzles to deposit material to be sprayed onto target objects and surfaces. Typically, a flow rate of sprayed material depends on the application and the type of material sprayed, and in some applications such as painting, coating and the like the amount of material sprayed onto the target object must be closely controlled.

In the past, various methods and devices have been proposed to measure the material provided through a spray nozzle. For example, one previously proposed solution involves measuring flow rate through a conduit providing the fluid or another material to a sprayer. Other solutions involve using a container having a known volume to collect fluid in a timed fashion.

### BRIEF SUMMARY OF THE DISCLOSURE

A first embodiment of the present disclosure provides a portable first container (e.g. tube) that collects flow and measures instantaneous incoming flow rate into the tube. It includes capacitive electrodes, affixed to the tube wall and extending along a major dimension, for example, a vertical direction of the tube along the length of the tube. Each capacitive electrode has an electrical property that corresponds to the localized presence or absence of material across the tube wall. The capacitive electrodes continuously transmit the electrical properties to a controller. The controller is programmed and operates to receive these properties, continuously interpret the amount of liquid present in the tube, calculate the instantaneous rate of change of the amount of liquid present in the tube, and communicate this instantaneous rate of change of the amount of liquid present in the tube to an output.

In an embodiment, multiple arrays of the capacitive electrodes are included and associated with a controller receiving electrical properties from each array. The capacitive electrodes within each array are arranged around and conform to the shape of an outer periphery of the tube wall such that measurements can be averaged to provide a true indication of the level of material in the tube even in conditions when the tube is not perfectly vertically positioned. Alternatively, in an embodiment, the device further includes a tilt metering device such as an electronic gyroscope. The controller receives this signal from the electronic gyroscope corresponding to this direction of gravity and is able to determine and account for tilt based upon this signal.

The capacitive electrodes may be externally affixed to the external surface of the tube wall such that the capacitive electrodes make no contact with the liquid accumulating in the tube, and can also be embedded in at least some of the tube wall. The electrodes are arranged to conform to the shape of the tube wall or other container such that their capacitive measurement is made to be more precise.

In an embodiment, a physical encumbrance to direct flow such as a funnel, or to smooth flow such as a sponge, or both, can be positioned at the open end of the tube, configured such that the fluid entering the tube does not run down the tube walls where the capacitive electrodes are positioned, interfering with the capacitive electrodes' detection of liquid.

In one embodiment, the flow-directing may be accomplished by other structures such as a tube extending along the container internally to receive flow at one end and deposit the flow at another end.

The device in accordance with the disclosure advantageously can be configured to measure conductive or non-conductive materials and fluids, aqueous or non-aqueous solutions, mixtures of different liquids, suspensions of solids in liquids, liquids containing entrained air or a gas, and the like. The devices can be reusable in whole or in part, or single use devices for materials that may permanently attach to the tube.

A second aspect of the present disclosure comprises a method of measuring flow rate. The method comprises various steps including capturing all of the flow deposited by a spray nozzle over a period of time within an internal cavity of a portable first container, such that the flow accumulates within the container during the period where flow is captured; detecting the amount of liquid from the flow with capacitive electrodes, each having an electrical property changing in response to the presence of a liquid in the internal cavity; each transmitting a signal corresponding to this electrical property to a controller, wherein the controller is programmed and operates to receive the signals, interpret the signals simultaneously with the receipt of the signals, or in real time, to determine the amount of liquid present in the internal cavity, calculating the instantaneous rate of change of the amount of liquid present in the internal cavity, and provide the calculated instantaneous rate of change of the amount of liquid present in the internal cavity to an output.

In one embodiment, capacitive electrode material can extend continuously along the height of the container such that a controller can continuously sense the level of fluid or other material as it collects in the container, and estimate or otherwise calculate a rate of collection of the fluid or material within the container. In another embodiment, discrete capacitive sensing areas can be placed along the height of the container, in a non-continuous fashion, to provide signals when the fluid or material collecting in the measurement container reaches those areas. With this information, and also a known or predefined spatial relation of the discrete sensing areas on the container, the controller can receive start/stop signals and calculate the rate of collection of the fluid or other material within the collection container. Additional sensing areas can also be used for ambient temperature and fluid/material property calibration such as capacitance, viscosity and the like, whether continuous sensing or discrete sensing areas are used on the collection container.

### BRIEF DESCRIPTION OF THE SEVERAL VIEWS OF THE DRAWINGS

FIG. 1 is an outline view of a flowmeter in accordance with the disclosure.

FIG. 2 is an outline view of the flowmeter of FIG. 1 in one operating condition in accordance with the disclosure.

FIG. 3 illustrates a block diagram for a flowmeter controller in accordance with the disclosure.

FIGS. 4A-4D illustrate various embodiments for exemplary capacitive electrode array configurations in accordance with the disclosure.

FIG. 5 illustrates an exemplary embodiment for a flowmeter in accordance with the disclosure.

FIG. 6 illustrates an exemplary embodiment for a flowmeter in accordance with the disclosure.

FIG. 7 illustrates an exemplary embodiment for a flowmeter in accordance with the disclosure.

FIG. 8 illustrates an exemplary embodiment of a shield for a flowmeter in accordance with the disclosure.

FIG. 9 shows an alternative embodiment of a flowmeter in accordance with the disclosure.

### DETAILED DESCRIPTION OF A PREFERRED EMBODIMENT

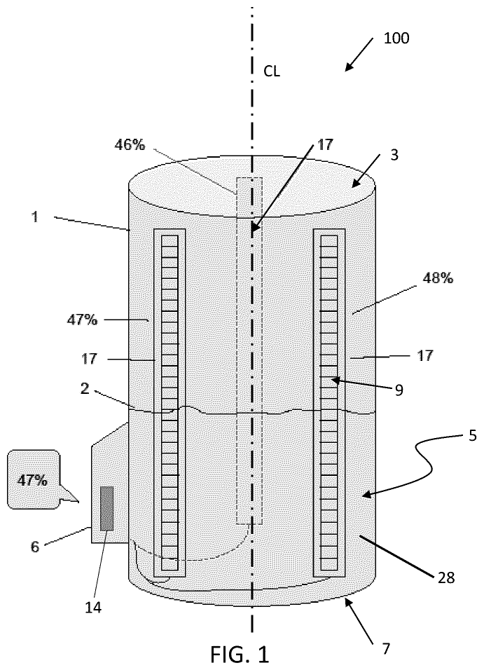

An outline view of an exemplary embodiment for a flowmeter 100 is shown in FIG. 1. The flowmeter 100 in the embodiment shown includes a portable material collection container (e.g. tube) 1 that is open on one end 3 and closed on the other end 7, the container 1 defining a collection cavity therein 28. During use, the container 1 may be placed beneath a spray nozzle (not shown) while the nozzle is emitting a liquid stream, spray or plume, such that the liquid exiting the nozzle may enter the container 1 through the open end 3 to enable a flow of fluid to enter and accumulate as a liquid at a liquid level 2 withing the collection cavity 28 of the container 1. As can be appreciated, while additional fluid enters the container 1 through the open end 3, the level 2 of the accumulating liquid may rise within the container 1 as the nozzle continues to spray liquid (or another material, for example, a solid aggregate material).

Capacitive electrodes 17 are attached along the side of the tube 1 on an outer surface 5 of the tube 1. It is contemplated that the electrodes 17, in any of the disclosed embodiments herein, can alternatively be attached on an inner surface of the tube 1, or even embedded within the wall thickness of the tube 1 such that they do not physically come into contact with the air outside of the tube or any fluids or material that may be deposited within the interior of the tube. In the illustrated embodiment, and regardless of the positioning of the electrodes relative to the tube 1, the electrodes 17 extend along a major dimension of the tube, for example, vertically, along a centerline CL of the tube 1 from an area adjacent the open end 3 to an area adjacent the closed end or base 7 of the tube 1, and conform to the shape of the outer surface of the container 1. In the embodiment shown, three electrodes 17 are attached symmetrically around a periphery of the outer surface 5 of the tube 1, but it is contemplated that as few as one electrode, two, or more than three electrodes can be used. Moreover, when more than one electrode 17 is used, their arrangement on the outer surface of the container 1 need not be symmetrical and can be asymmetrical around the periphery and/or along the height of the container.

Each electrode 17 is a capacitive electrode that includes at least an electrically conductive portion coupled with a dielectric layer. The capacitive electrodes can be configured as surface capacitance sensors or projected capacitance sensors, as those technologies are currently known and understood. To improve sensing accuracy and sensor resolution, each electrode 17 may include two or more graduations or sensing elements or areas 9 that are arranged in a one-dimensional or two-dimensional configuration along the dielectric layer, which dielectric layer conforms to the surface of the container. Each electrode 17 and, as shown in the embodiment illustrated in FIG. 1, each area 9, is provided with an electric voltage such that a capacitance created adjacent each portion of the electrode 17, or each of the individual areas 9, changes depending on whether there is presence of a material, such as the liquid or a solid aggregate and the like, in the tube 1, at a level 2 that overlaps one or more areas 9 of each electrode 17.

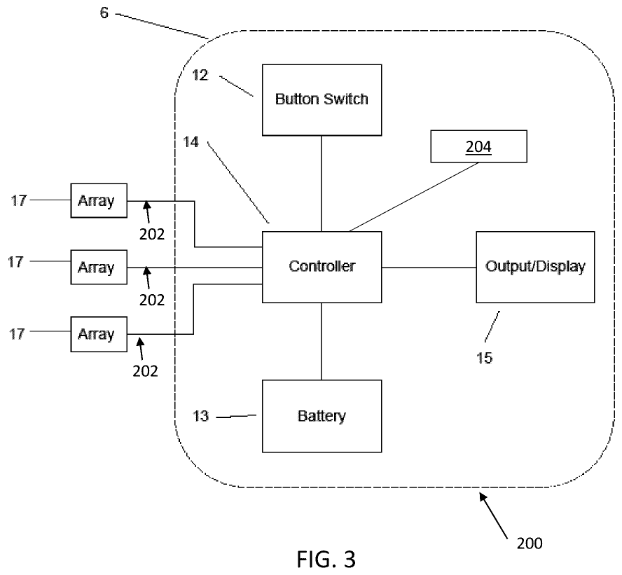

As the level 2 of material within tube 1 increases, the overall capacitance of each electrode 17 will change depending on the size, position and arrangement of sensing elements or areas 9 along each electrode 17 and their position on the outer surface of the container 1. The changing capacitance sensed by the sensing elements as the container fills can thus provide a respective electrode signal(s) from the electrode(s) 17 that also changes and that is indicative, for example, proportional, of the level 2 of material within the tube 1. The signal provided by the electrodes will also be indicative of the actual level of material in the tube 1, such that a timed monitoring of the signal will provide information indicative of the instantaneous level 2 of material in the tube 1, and also information indicative of the rate of change of material within the tube or, stated differently, the rate at which the tube 1 is filling with material. The signal(s) from the electrodes 17 are provided to a controller 14 which receives and monitors the signals, as shown in the block diagram of FIG. 3. The controller includes a power source that provides power to operate the electrodes 17 and also a processing unit for receiving and processing signals provided back to the controller by the electrodes during operation.

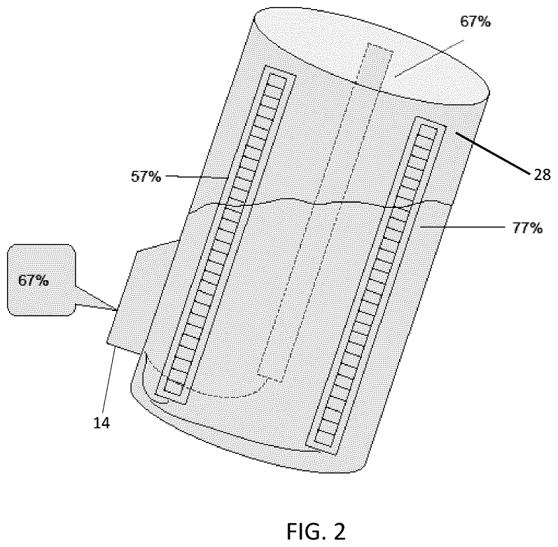

The arrangement of electrodes 17 on and around the tube 1 can be selected to improve measurement accuracy. For example, as shown in FIG. 1, and also in FIG. 2, which illustrates the flowmeter 100 in an inclined operating position, an arrangement of three electrodes 17 symmetrically around the tube 1 is configured to measure different fluid or material levels within the tube 1 while the tube is used in an inclined position, i.e., it is held by the user in a non-vertical position while the container is filling with fluid. In the exemplary operating position shown in FIG. 2, the flowmeter 100 may be inclined such that the level 2 of the material within the tube 1 will cover opposing walls of the tube 1 at different levels. As shown, for example, the electrode 17 on the right side of the figure may show a 77% fill, while another electrode 17 on the left side may show a 57% fill. An electrode 17 on the rear may show an intermediate fill level at 67%. In general, depending on the arrangement of electrodes 17 around the periphery of the tube 1, a weighted or straight average of their individual readings may be calculated to arrive to a true level of the material within the tube for purposes of determining the flow rate of material into the tube on the basis of the level of the material.

A block diagram for a controller 200 is shown in FIG. 3. In the illustrated embodiment, the controller 200 receives signals 202, as shown, one signal 202 from each of the electrodes 17. The signals 202 are indicative of the level and also the rate of change of the level of material (shown as level 2 in FIG. 1) within a collection cavity such as the tube 1 of the flowmeter 100 (see FIG. 1). The signals 202, or a single signal 202 in the case where a single electrode is used, or more than one signal, if multiple electrodes and/or other sensors are used, are provided to a controller 14. The controller 14, which may be implemented in software or hardware and be programmable to execute computer executable instructions, is programmed and configured to monitor, in real time or synchronously during operation, a level of the material collected into the flowmeter 100 at each instant of time, or in a predetermined and period interval, for example, at a sampling frequency of 100 Hz. Higher or lower sampling frequencies can also be used. A time series of readings from each sensor may be processed by the controller 14 to indicate the absolute value and also a rate of change or derivative of the fluid level measurement. For example, the volume of fluid may be updated in real time in an appropriate unit of measurement such as in milliliters (ml), and the rate of change of the volume of material can be expressed also in an appropriate measurement such as in ml per second (ml/sec). The measurement units may vary and may further be selectable by a user.

The controller 14 may further include additional structures that are known for use with such devices such as a permanent memory, a volatile memory, and processor, transceiver circuits and the like. In the embodiment shown, the controller 200 further includes a power supply or battery 13 for powering the controller 14, a button or switch 12, which may be used to activate the controller 200 and/or initiate and terminate measurement processes, and an output or display 15, which may be used to indicate the values calculated by the controller 14. The output 15 may be a local display on the flowmeter 100 and may also include remote connectivity for transmitting the information to another device such as a cellphone or plant controller using an appropriate wireless and/or wired communication protocol. Additional sensors 204 may also be used, for example, temperature and pressure sensors, which provide environmental information to the controller 14 and also material-specific information about the material being collected in the flowmeter, for example, temperature, which together with predefined information present in the controller's memory about the particular material to be measured such as material density, viscosity etc. can be used to perform corrections to the volume and flowrate values calculated by the controller. The additional sensors 204 may also include a gravity sensor, which provides an indication to the controller of any inclination of the device for use in correcting the various electrode sensor readings.

The controller can calculate volume based on the level of material in the flowmeter, expressed as a height, multiplied by a cross-sectional area of the flowmeter container (tube 1) at any given height, which is a known parameter that depends on the shape of the flowmeter container. In the embodiment shown in FIG. 1, for example, the height may be the level 2 of the liquid and the area may be the cross sectional area of the tube 1.

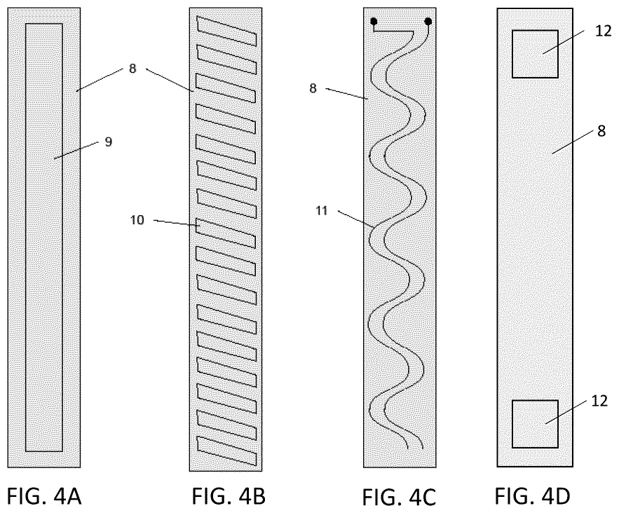

Some exemplary, alternative arrangements for electrodes 17 are shown in FIGS. 4A, 4B, 4C, and 4DC. In reference to these figures, it can be seen that the sensing element or electrode 9 can be shaped as a single area or multiple areas (see FIG. 1) onto a substrate 8. Alternatively, electrical conductor areas 10 can be formed in segments separated by spaces onto the substrate 8 to provide more discrete, rather than continuous level readings. Such an arrangement may be selected for higher flowrates of material collected into the flowmeter. A continuous but non-linear electrode sensing area 11 on a substrate 8 can also be used for applications that are expected to require a higher sensing resolution for slower flowing material into the flowmeter. In one embodiment, differently shaped electrodes can be combined in a single flowmeter to achieve a higher accuracy of measurement for different flow rates expected. For example, a uniform shaped electrode 9 as shown in FIG. 4A can provide a continuous indication of fluid level to the controller. Two or more discrete electrodes 10 as shown in FIG. 4B can provide discrete level indications as the container fills with material. If additional resolution is required, i.e., by use of an electrode that is longer than the height of the container, any shape of electrode 11 such as a sinusoidal wave shape can be used as shown in FIG. 4C. If discrete start and stop indications are desired, for example, to initiate and terminate a timer while the container is filling to acquire an average fill rate for the container, two spaced electrodes 12 can be used, as shown in FIG. 4D.

The technology disclosed is such that physical contact by the capacitive electrodes 17 with the liquid 2 is unnecessary. The capacitive electrodes 17 will typically be externally affixed to the tube walls, by means such as fastening, gluing, crimping, etc. or embedded into a substrate 8 that is similarly affixed to the outside of the tube 1. However, some implementations may embed the capacitive electrodes 17 within at least some of the tube wall 2. The substrate 8 can be made of a dielectric material to minimize interference with the capacitive electrodes 17 and may be rigid or flexible. The capacitive electrodes 17 can alternatively be embedded in the tube wall 1 or printed onto the side of the tube 1, or utilize some similarly appropriate method, especially in light of advancing technologies in the application of capacitive electrodes 17, including but not limited to 3D printing.

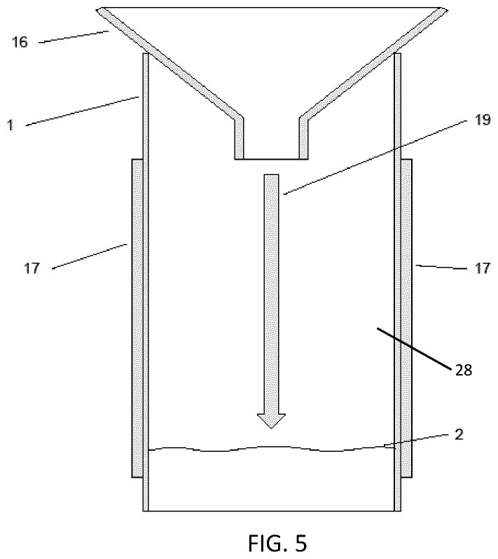

As can be appreciated, the shape of the collector for the material can affect the accuracy of the measurement. For example, a single electrode placed along one side of a tubular collector can advantageously measure the level of a fluid collected in the tube provided that the fluid enters the tubular collector in a stream that does not flow over the area of the sensor, which may hide or distort a proper reading of the fluid level while the tube is filling. To mitigate such possible conditions, flow directing devices may be used such as shown, for example, in FIG. 5. In this embodiment, a funnel 16 is placed at the open end of the tube such that a fluid flow 19 may centrally enter the tube 1 without touching the walls onto which the electrodes 17 are placed.

Moreover, the tube 1 may be formed by a thickness of material that forms the walls of the tube selected based on the type of fluid being measured and the size of the tube so as not to distort any electrode readings. For example, a common example of the arrangement would place measurement electrodes at a distance of twice the wall thickness from reference electrodes. The material of said tube's wall 1 is generally a dielectric material to similarly enhance the capacitive electrodes' reactivity with the liquid 2 across the tube wall 1.

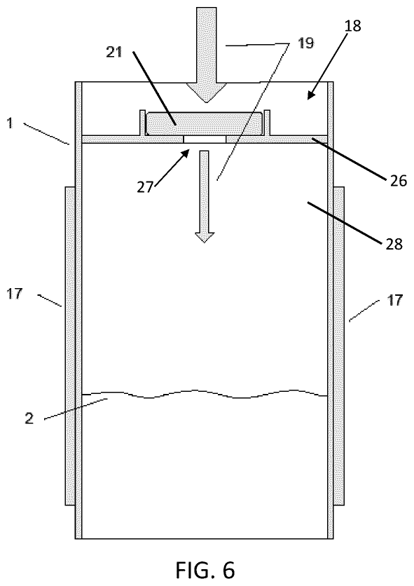

An alternative embodiment for the flowmeter 100 is shown in FIG. 6. In this embodiment, which can be useful for highly agitated flows provided a spray nozzle, the flow meter can include a pre-chamber 18 that can be formed in a separate component or as part of or as a portion of the internal cavity or collection chamber of the flowmeter collector or tube 1. The pre-chamber 18 may collect a spray plume of fine droplets or particles from a nozzle and coagulate or precipitate them into a flowable liquid stream that passes through an opening 27 in a dividing wall 26 disposed between the pre-chamber 18 and a main chamber 28 of the flowmeter collector. Optionally, and depending on whether gas droplets may be entrained in the liquid, a flow smoother made from a liquid permeable material such as a sponge 21 may be used to process and de-aerate the fluid as it passes through the opening 27. The sponge 21 is thus placed to block the opening 27 and thus force the fluid to centrally flow into the main chamber 28.

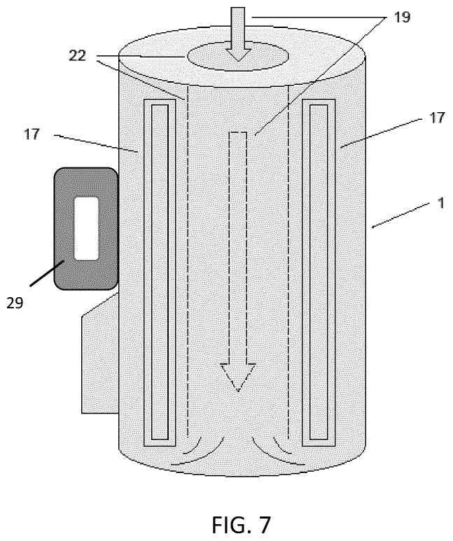

In yet another alternative embodiment, a flow directing channel or chute 22 may be disposed within the tube 1 to centrally direct the flow into the tube 1, as shown in FIG. 7. As is also shown in this embodiment, it is contemplated that the tube or container 1 is portable and even hand-held by a user that places the open end of the container 3 beneath the discharge of a spray nozzle. In this embodiment, the container 1 includes a handle 29 placed externally on the container and enabling a user to grasp and hold the container during use.

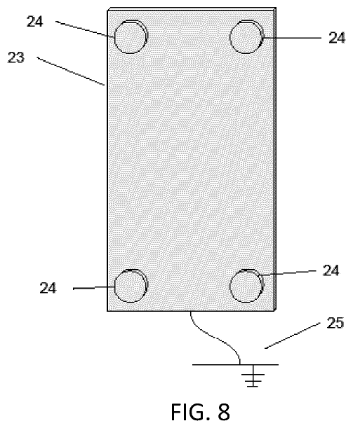

In one embodiment, the capacitive electrodes 17 are shielded from external forces or physical wear or damage by a shield assembly 23, as shown in FIG. 8. In this embodiment, the shield 23 provides an added layer of protection from external interference. These external forces include but are not limited to those of hands and digits. External forces can create false positives or red herrings or noise that muddle the sensitivity and accuracy of the test. This shield is made of a plate 23 of conducting material that is grounded to a ground 25. The shield plate 23 includes spacers 24 made of a material of low permittivity such as plastic. The spacers 24 can be configured to protect the electrode placed below the shield from contact externally when the spacers are placed onto the wall of the flowmeter container, for example, the outer surface of the tube 1.

An implementation of the disclosure's capacitive electrodes can be designed in such a way as to register the presence or absence of aqueous and non-aqueous solutions, fluid and non-fluid flows, and mixes of air and liquid 2. Non-fluid flows 19 will include powders and similarly solid but non-rigid materials capable of being poured or sprayed 19.

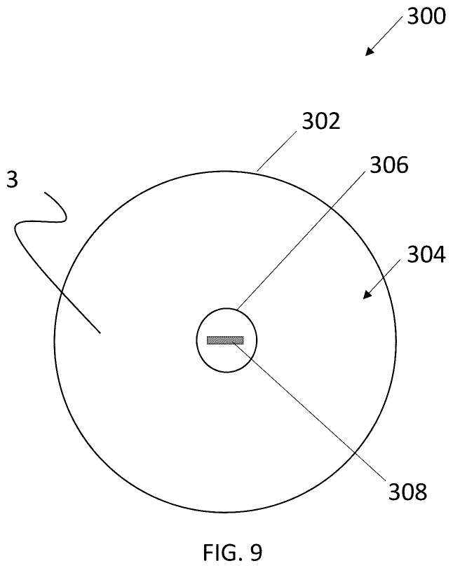

An alternative embodiment for a flowmeter 300 is shown in FIG. 9. In this embodiment, the flowmeter includes a generally cylindrical wall 302 (shown from the top, open end) having a closed end and an open end 3. A volume 304 is defined within the wall 302, into which material can be collected, as described in the embodiments above. The flowmeter 300 further includes a central post 306, which extends centrally along a longitudinal axis of the cylindrical wall 302, similar to the chute 22 (FIG. 7). Unlike the chute 22, the post 306 is solid and encapsulates therein an electrode 308. The electrode 308 has a generally elongate shape that extends along a centerline of the cylindrical wall 302 over substantially an entire length of the collection area 3 of the flowmeter 300. During operation, material collected in the chamber 304 is registered by the capacitive electrode 308. The central positioning of the electrode 308 within the chamber 304 ensures an accurate measurement even if the flowmeter is operated at an angle (see, e.g., FIG. 2).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A flowmeter, comprising:
a container having a sidewall, the sidewall defining an open end, a closed end, and a collection cavity therein, the sidewall extending along a major dimension between the open end and the closed end;
at least one capacitive electrode disposed in proximity to the collection cavity, the at least one capacitive electrode having an elongate shape extending along the major dimension, wherein one end of the at least one capacitive electrode is disposed adjacent the closed end of the sidewall, and wherein another end of the capacitive electrode extends towards the open end of the sidewall;
a controller disposed on the container, the controller including a power source and operably associated with the at least one capacitive electrode, the controller configured to provide power from the power source to operate the at least one capacitive electrode, the controller further comprising a processing unit configured for receiving signals from the at least one capacitive electrode and process the signals;
wherein the processor is programmed and configured to process the signals to determine a volume of material present in the collection cavity and a rate of change of the volume of material present in the collection cavity.

2. The flowmeter of claim 1, wherein the container is a hollow tube having the open end at one side and the closed end at the other side, and wherein the collection cavity is defined within and along the hollow tube, wherein the major axis is a centerline of the hollow tube, and wherein the hollow tube has a uniform cross sectional area along the centerline.

3. The flowmeter of claim 2, wherein the at least one capacitive electrode is associated with the sidewall, and wherein the flowmeter further includes a second capacitive electrode, the second capacitive electrode disposed at a diametrically opposite location from the at least one capacitive electrode along the centerline.

4. The flowmeter of claim 1, further comprising a plurality of additional capacitive electrodes, the at least one capacitive electrode and the plurality of additional capacitive electrodes disposed symmetrically around the sidewall and being connected to the controller.

5. The flowmeter of claim 4, wherein the processor is further configured to receive additional signals from the plurality of additional capacitive electrodes, and wherein the processor is further programmed and configured to process the additional signals and determine the volume of material and the rate of change of the volume of the material based on an average of the signal and the additional signals.

6. The flowmeter of claim 1, wherein the at least one capacitive electrode is embedded within a material of the sidewall.

7. The flowmeter of claim 1, wherein the processor is configured to determine a rate of change of the volume of material synchronously while the flow meter is adapted to receive a flow of material through the open end that collects within the collection cavity.

8. The flowmeter of claim 7, wherein the controller further includes a display configured to provide a visual indication of the rate of change of material synchronously with the rate of change calculated by the processor.

9. The flowmeter of claim 1, further comprising a flow direction device associated with the container, the flow direction device adapted to redirect a material flow into the open end towards a predefined area in the collection cavity away from the at least one capacitive electrode.

10. The flowmeter of claim 1, further comprising a shield disposed over at least a portion of the at least one capacitive electrode.

11. The flowmeter of claim 1, wherein the controller further includes additional sensors, the additional sensors operating to provide corresponding signals indicative of at least one of a temperature of material present in the collection cavity, and ambient temperature, a direction of gravity, and a viscosity of material present in the cavity.

12. A method for measuring a flowrate of material provided through a spray nozzle, the method comprising:
providing a container having a sidewall, the sidewall defining an open end, a closed end, and a collection cavity therein, the sidewall extending along a major dimension between the open end and the closed end;
providing at least one capacitive electrode disposed on the sidewall, the at least one capacitive electrode having an elongate shape extending along the major dimension, wherein one end of the at least one capacitive electrode is disposed adjacent the closed end of the sidewall, and wherein another end of the capacitive electrode extends towards the open end of the sidewall;
providing a controller disposed on the sidewall, the controller including a power source and operably associated with the at least one capacitive electrode, the controller configured to provide power from the power source to operate the at least one capacitive electrode, the controller further comprising a processing unit configured for receiving signals from the at least one capacitive electrode and process the signals;
placing the open end beneath a spray nozzle, and collecting material exiting the spray nozzle within the collection cavity through the open end; and
determine a volume of the material present in the collection cavity and a rate of change of the volume of material present in the collection cavity using the processor based on the signals from the at least one capacitive electrode.

13. The method of claim 12, wherein the container is a hollow tube having the open end at one side and the closed end at the other side, and wherein the collection cavity is defined within and along the hollow tube, wherein the major axis is a centerline of the hollow tube, and wherein the hollow tube has a uniform cross sectional area along the centerline.

14. The method of claim 13, wherein calculating the volume of the material present in the collection cavity is accomplished by sensing a height of the material using the at least one capacitive electrode and multiplying the height by the uniform cross sectional area using the processor.

15. The method of claim 13, further comprising providing a second capacitive electrode, the second capacitive electrode disposed at a diametrically opposite location from the at least one capacitive electrode along the centerline.

16. The method of claim 12, further comprising providing a plurality of additional capacitive electrodes, the at least one capacitive electrode and the plurality of additional capacitive electrodes disposed symmetrically around the sidewall and being connected to the controller.

17. The method of claim 16, wherein determining the volume and the rate of change of the volume of the material in the collection chamber further includes processing the additional signals and determining the volume of material and the rate of change of the volume of the material based on an average of the signal and the additional signals calculated using the processor.

18. The method of claim 12, wherein the processor is configured to determine a rate of change of the volume of material synchronously while the flowmeter is collecting material through the open end.

19. The method of claim 18, further comprising displaying on the flowmeter a visual indication of the rate of change of material synchronously with the rate of change calculated by the processor.

20. The method of claim 12, further comprising providing a flow direction device associated with the container, and redirecting a flow of the material exiting the spray nozzle that passes through the open end away from the at least one capacitive electrode.
